(19) United States
(12) Patent Application Publication
(10) Pub. No.: US 2010/0229220 A1
(43) Pub. Date: Sep. 9, 2010

(54) System and method for theft and data recovery from lost portable devices

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/583,609

(22) Filed: Aug. 24, 2009

Related U.S. Application Data
(60) Provisional application No. 61/209,053, filed on Mar. 3, 2009.

(51) Int. Cl. G06F 21/20; G06F 15/16

(52) U.S. Cl. 726/4; 709/224

(57) ABSTRACT

A system and method for theft recovery, data recovery, and privacy protection for portable devices with IP connectivity is implemented either according to a peer-to-peer or client-server model, with a serverless or a server-based infrastructure. In the P2P model, a distributed hash table (DHT) algorithm is used for storing and retrieving the device IP addresses and the device location coordinates when available. An authorized user can set a protected device into a locked mode or the device automatically enters into a locked mode after the device has been operated without proper authorization. In a locked mode, private data is deleted, transferred to a pre-selected storage system, alerts and location coordinates, when available, are to be sent to preselected accounts. Data on a lost portable device can be synchronized with a pre-selected storage system and be restored when the lost device is recovered.

### CROSS REFERENCE TO RELATED APPLICATION

This application claims the benefit of U.S. Provisional Patent Application Ser. No. 61/209,053, filed Mar. 3, 2009, the disclosure of which is herein expressly incorporated by reference.

### FIELD OF THE INVENTION

The present invention relates in general, to theft prevention and data recovery for lost portable devices, and more particularly, to tracking, theft prevention, data recovery, and privacy protection for lost or stolen portable devices with IP (Internet protocol) connectivity such as cell phones, laptops, personal digital assistants, other portable consumer electronics, and other portable commercial electronics.

### BACKGROUND OF THE INVENTION

The introduction of smartphones such as iPhone and Google phones (e.g., G1) has fundamentally changed the landscape of the mobile phone and PC (personal computer) related industries. On one hand, a smartphone has become a mini-PC; a user can install all kinds of application software. In addition to the common functions in a feature phone, users nowadays store personal data, browse the Web, read and write emails, and take and view pictures and videos. On the other hand, a portable PC such as a laptop or a special-purpose portable device such as a PDA (personal digital assistant) or a PMP (portable media player) is sometimes equipped with mobile voice functionality. The consumer prefers to carry only a single portable all-in-one device; this trend is obvious and inevitable.

As the devices become smaller and the features become richer, the value of lost portable devices becomes greater. There are two kinds of value in a lost or stolen portable device. One is obviously the economic value of replacing the lost device, and the other is the loss of intangible private data.

Hereafter, a mobile phone device is meant to be a device that is equipped for mobile voice service (cellular or voice over IP). In such a device, a personal contact list is always present. In a more elaborate device, emails, personal profiles, family pictures and videos, and other private data are often present. If the individual user is a business executive, the stored data can be highly valuable.

Even for ordinary consumers, if a lost portable device contains irreplaceable private data, the intangible cost can be very high. Therefore, it is easy to build a business case for theft prevention, data recovery, and privacy protection for lost portable devices.

The present invention, called gTrack, provides a system and methods to prevent theft, recover data, and protect privacy for any lost or stolen portable device that is either costly to replace or costly in the loss of private data.

The functions provided by gTrack are divided into three groups: theft recovery (TR), data recovery (DR), and privacy protection (PP). The DR functions can also be used as backup synchronization (BS) functions.

In all these operations, communications between a lost device and an authorized user are done through an IP or Internet connection. A key differentiator of the present invention is that all communications are conducted in two possible ways: either P2P (peer-to-peer) or client-server. In particular, the IP location of a lost device can be obtained through a P2P search algorithm based on DHT (distributed hash table). Such an algorithm has the distinction that the needed distributed infrastructure is either serverless or server-based.

Theft recovery is a well-known concept; in the car industry, the famous example is the LoJack vehicle recovery system. This idea has been extended to all kinds of devices and assets, including cell phones and PCs. One differentiator of the present invention is that the anti-theft functions uniquely leverage on IP connections via a P2P or client-server infrastructure.

Data recovery is another well-known concept; however, in the context of the present invention, the reason for data recovery is not device damage, but the loss of a device due to theft or inadvertent events. A key differentiator of gTrack is that the data recovery operations are designed as a subset of backup synchronization operations. Therefore, DR operations, according to the present invention, are BS operations after the loss of a device.

Privacy protection is yet another classic concept in the Internet era. A key differentiator of the present invention is that the gTrack TR-DR-PP software cannot be uninstalled by an ordinary means; the software will re-install itself in the background if the uninstall is not done by an authorized user. The PP operations are either automatic or started by an authorized user.

Yet another key differentiator of the present invention is that in a group of embodiments, gTrack TR-DR-PP functionality is offered in conjunction with a property insurance product that protects against loss or theft of a portable device. This combination makes sense as the TR-DR-PP functionality creates strong incentives for a non-owner to return a stolen or lost portable device.

### BRIEF SUMMARY OF THE INVENTION

It is, therefore, an object of the present invention, through a system called gTrack, to accomplish three classes of operations: theft recovery (TR), data recovery (DR), and privacy protection (PP), for a portable device with an IP connection that is stolen or inadvertently lost.

A device suitable for the gTrack system is one that is portable and IP connectable. Therefore, the set of applicable devices includes any portable device with or without mobile voice service, portable PCs, portable consumer electronic devices, and portable commercial electronic devices.

The three sets of operation (TR, DR, and PP) are activated automatically once a device is operated without proper authorization. All communications between an authorized user and a lost device are done through a P2P or client-server infrastructure, or both.

In accordance with one aspect of the present invention, the IP address discovery and tracking of a lost device is optionally accomplished through a DHT-based distributed P2P infrastructure, with or without servers.

The set of theft recovery operations includes: locking a lost portable device, reporting the location of a lost device, and reporting private user data.

The set of data recovery operations includes: data transfers between a lost device and an authorized storage system, and backing up sensitive data from a lost device.

The set of privacy protection operations includes: deletion of sensitive data, sending alerts to the law enforcement authorities and an authorized user, logging out from online accounts, and preventing unauthorized uninstalls.

The gTrack system can be integrated with a property insurance product that protects against loss or theft of portable devices. The gTrack features provide a strong incentive for a non-owner to return a lost portable device, thus reducing the operational expenditure of the insurance business.

### BRIEF DESCRIPTION OF THE DRAWINGS

The above and other objects and features in accordance with the present invention will become apparent from the following descriptions of embodiments in conjunction with the accompanying drawings, and in which:

FIG. 1 depicts a gTrack overlay network setup;

FIG. 2 shows message exchange between gTrack-MD modules;

FIG. 3 illustrates the structure and fields of messages in a gTrack protocol;

FIG. 4 shows a server-based setup for gTrack;

FIG. 5 shows the interaction between application and its background uninstall dual;

FIG. 6 shows a control flow chart between an application and its background install dual.

### DETAILED DESCRIPTION OF EXEMPLARY EMBODIMENTS

The present invention enables a system called gTrack, which deals with devices that can be easily stolen or misplaced. Thus, such a device is one that is lightweight enough to be hand-carried. In addition, the device must have IP connectivity.

Optionally, the device should be trackable: it could be tracked approximately with location coordinates such as {latitude, longitude} pairs. Such trackability is usually accomplished by a GPS (global position system) receiver. However, a device can also be tracked to within proximity using the IP address to which the device is attached. The gTrack system works with a device with or without GPS trackability. Hereafter, the devices suitable for gTrack will be called portable devices.

A particular class of devices suitable for gTrack is those equipped with mobile voice capability. In sum, gTrack-suitable devices include, while not being restricted to, PCs (laptops, palmtops, desktops, tablets, and ultra mobile PCs), feature phones, smartphones, PDAs, PMPs, game stations, switches, routers, other consumer electronic devices, and other commercial electronic devices.

The description of the gTrack system is divided into two parts: communications and data.

First, communications between a portable device and other IP devices are conducted according to either the P2P or client-server model, or both. A key differentiator of gTrack in communications is the use of DHT-based overlay networks for storing and retrieving IP addresses of connected portable devices.

A DHT-based overlay infrastructure is a P2P network of peer nodes; each peer node acts both as a server and as a client. A peer or overlay node does not have to be computing or communication resourceful; it only has to perform basic computing and communications functions, while it can attach to or detach from an overlay network intermittently.

A DHT-system is set up as a distributed database. A key is used as the inquiry input to retrieve a data item from the distributed database, using a DHT mapping in the store and retrieval mechanism. In the present invention, a search key is the identifier of a portable device, and a primary data item for retrieval is the active IP address of a portable device.

To use a DHT-based overlay, it is required that each portable device has a unique global identifier. For a mobile phone device, it is most natural to use the phone number (the international standard is E.164) as its unique identifier. For a non-phone device, or a mobile phone device using a VoIP (voice over IP) number—which identifies the user than the device—the natural choice is the MAC (media access control) address, which is globally unique. While MAC addresses are a good choice, they are not a user-friendly. In accordance with one aspect of the present invention, an email address or a phone number is used as the primary identifier for the set of gTrack-protected devices owned by a user. Then a user employs a secondary identifier to differentiate between his different devices. As the secondary identifier is chosen by individual users; these identifiers are user-friendly. Thus a gTrack system allows a composite identifier for a portable device in the form of {email address or phone number, secondary identifier}.

Hereafter, the terms portable device and node will be used interchangeably.

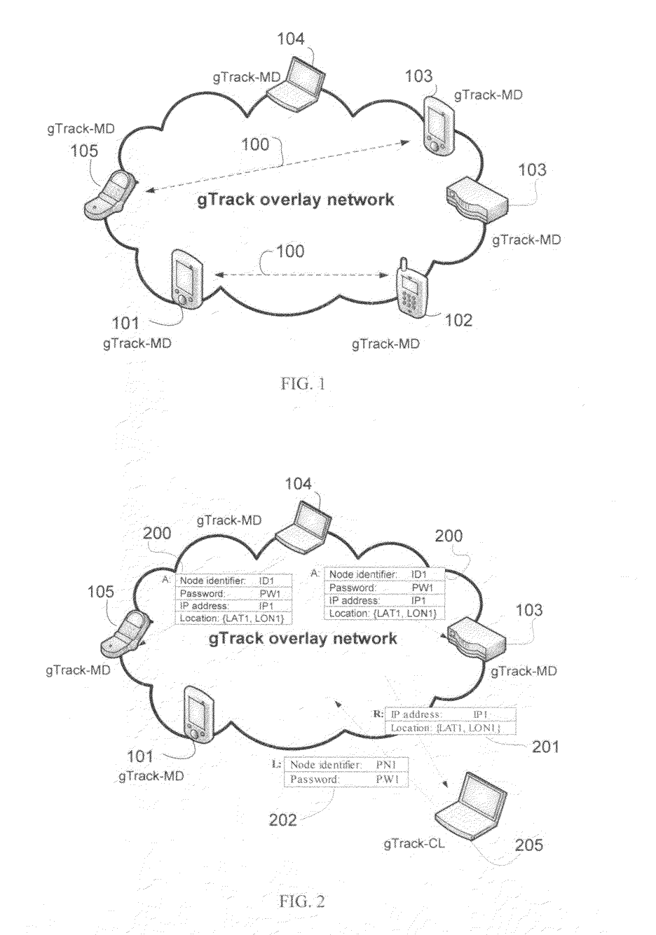

FIG. 1 describes a DHT-overlay embodiment of gTrack system. In one of its forms, gTrack is embodied as a software module downloadable and installable directly on a portable device. The portable device version of gTrack is referred to as gTrack-MD. Portable devices (101-105) connect to each other via gTrack message exchanges (100) in a gTrack overlay network.

Message transactions between nodes inside and outside of a gTrack overlay are illustrated in FIG. 2. First, an ADVERTISEMENT message A 200 is forwarded to the overlay and stored at one or more of the nodes, say N, in accordance with the DHT algorithm (in the example, N can be any of the nodes 101, 103 or 104). The ADVERTISEMENT message includes 4 pieces of information: the identifier of the node ID1, the password previously specified by the user (PW1), the current IP address of the node (IP1) and its current location expressed in terms of its latitude-longitude coordinates {LAT1, LON1}. The system allows for the retrieval of the information stored by message A from any Internet node with access to the overlay network.

In accordance with one aspect of the present invention, a user can retrieve data using a laptop 205 that runs a client version of gTrack, referred as gTrack-CL. The gTrack-CL module will issue a LOOKUP message L 202 to the overlay network containing a node identifier PN1 with an associated password PW1. The DHT search algorithm ensures correctness in that the LOOKUP message L 202 of the information stored by ADVERTISEMENT message A 200 will be forwarded to node N where message A had previously being stored. Upon receiving L, node N checks password PW1 against the identifier PN1 (in FIG. 2, ID1=PN1). If the passwords do match, node N returns a response R 201 including IP address IP1 and GPS location {LAT1, LON1}.

It should be noted that, while a gTrack-CL module may be part of a gTrack overlay, it can also reside outside of a gTrack overlay. A gTrack-CL module can communicate with a gTrack overlay from outside through a gateway of the intended overlay; this situation is illustrated in FIG. 2.

In most embodiments of the present invention, all messages—ADVERTISEMENT, LOOKUP, and RESPONSE—are delivered via an encrypted medium such as a secure socket layer (e.g., HTTPS).

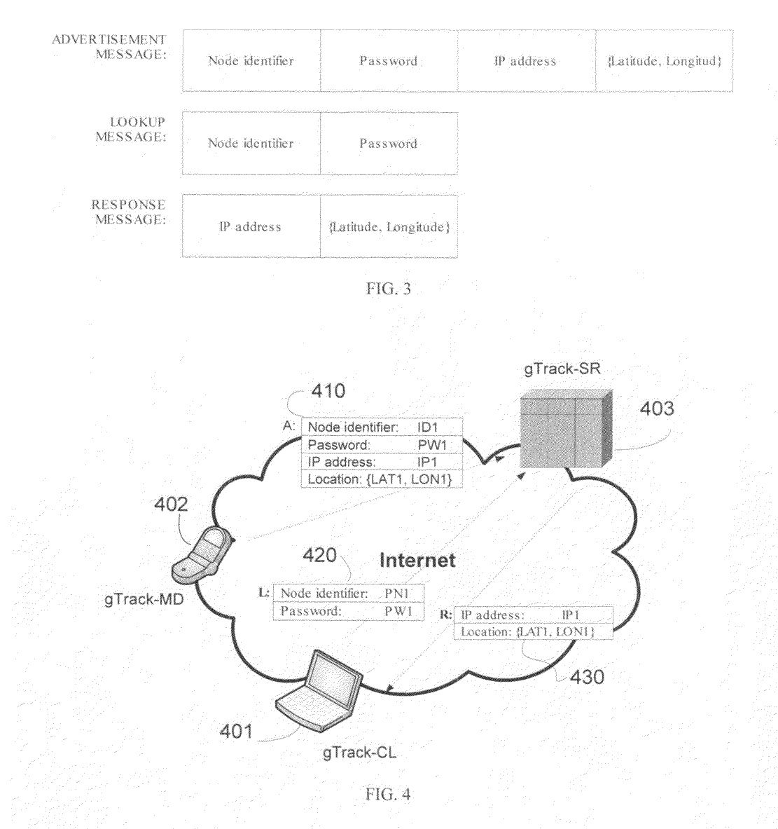

According to yet another embodiment of the present invention, ADVERTISEMENT messages are sent periodically. In particular, an ADVERTISEMENT message is sent every time the IP address or the location of the portable device changes, with a preset minimum time between transmissions. A summary of example messages is depicted in FIG. 3.

In another embodiment of the present invention, a gTrack system is implemented via a server-based infrastructure, as illustrated in FIG. 4. The functions previously performed by a P2P overlay network are now implemented by a centralized server system 403 which runs a version of gTrack called gTrack-SR. Here, the same messages utilized in the overlay setup are reutilized so that the gTrack-MD and gTrack-CL modules can be programmed to support both setups. In the server-based setup, an ADVERTISEMENT message A 410 is sent from a gTrack-MD device 402 to a gTrack-SR device, a LOOKUP message L 420 is sent from a gTrack-CL device 401 to a gTrack-SR device 403 and a response R 430 message is sent from a gTrack-SR device 403 to a gTrack-CL device.

In a particular embodiment of the present invention, both gTrack-MD and gTrack-CL modules are installed on the same portable device; thus, a user can identify the current location of a portable device using the same device or another device running these modules.

The data part of the gTrack operations are divided into three groups: theft recovery (TR), data recovery (DR), and privacy protection (PP).

The set of theft recovery operations includes: (1) locking a lost portable device, (2) reporting the location of a lost device, and (3) reporting private user data.

For TR operations, an unauthorized use of a portable device is characterized by one of the following: (1) failure to authorize for operating the device, (2) failure to authorize for uninstalling the gTrack software, (3) attempt to use the device after it has been set to “user locked mode” by an authorized user. If an authorized user has decided that a missing portable device has been lost, he can use a gTrack-CL module to instruct the missing device to lock. Such a locked mode is called “user locked” to be distinguished from the “automatic locked mode.” A gTrack portable device will enter into the “automatic locked mode” once the device has been operated without authorization.

A gTrack portable device in the locked mode (either user or automatic mode) will forward the location coordinates (when available) of the locked portable device on a periodic basis or upon request from an authorized user, to preselected accounts through a gTrack-CL module. Upon request, a gTrack portable device in the automatic locked mode will also send private user data (such as contact list, emails, etc.) from a lost device to preselected accounts. This action will expose an unauthorized user's private data, making a stolen device dangerous to use.

Usually, data recovery operations are performed during a locked mode to recover private data stored in a lost portable device. However, in accordance with one aspect of the present invention, the same operations are also allowed in the non-locked mode. In the non-locked mode, these operations are part of the normal backup synchronization process.

The present invention enables automatic file transfers between a gTrack portable device and a selected storage system. The storage system can be attached to a PC, or another computing device, or a Web-based storage system. The files have to be preselected by a gTrack user in automatic transfers. A gTrack device will start an automatic transfer, after a set minimum wait time between backups, or upon detection of sufficient modifications to the selected files. In the manual file transfer mode, an authorized user selects the files to be transferred between a portable device and a storage system. The gTrack file transfer functions can also be used as a restoration measure—if some files have been lost or damaged, gTrack-MD can be used to restore affected files via transferring from a storage system.

In accordance with one aspect of the present invention, the privacy protection operations are all performed in a locked mode. These operations include: deletion of sensitive private data, sending alerts to the law enforcement authorities and authorized users, logging out from online accounts, and preventing unauthorized uninstalls of the gTrack software.

Again, these operations can be done in an automatic or manual mode. In the automatic mode, all specifications (which files or data to delete, where to send alerts, which accounts to logout, etc.) are set either by default or an authorized user. In accordance with one aspect of the present invention, in the manual mode, an authorized user is enabled to take effective control of the lost device, whenever the device is online, through an IP connection.

As part of theft recovery features, the present invention also provides a unique method to prevent unauthorized uninstall of critical software such as the gTrack applications. To operate a portable device, a user is often required to be authenticated through a login process via a password or biometric verification. However, it is rare to require an authentication to uninstall critical applications. As gTrack provides a critical defense against malicious users, as an option, the gTrack software comes with an anti-theft uninstall protection mechanism.

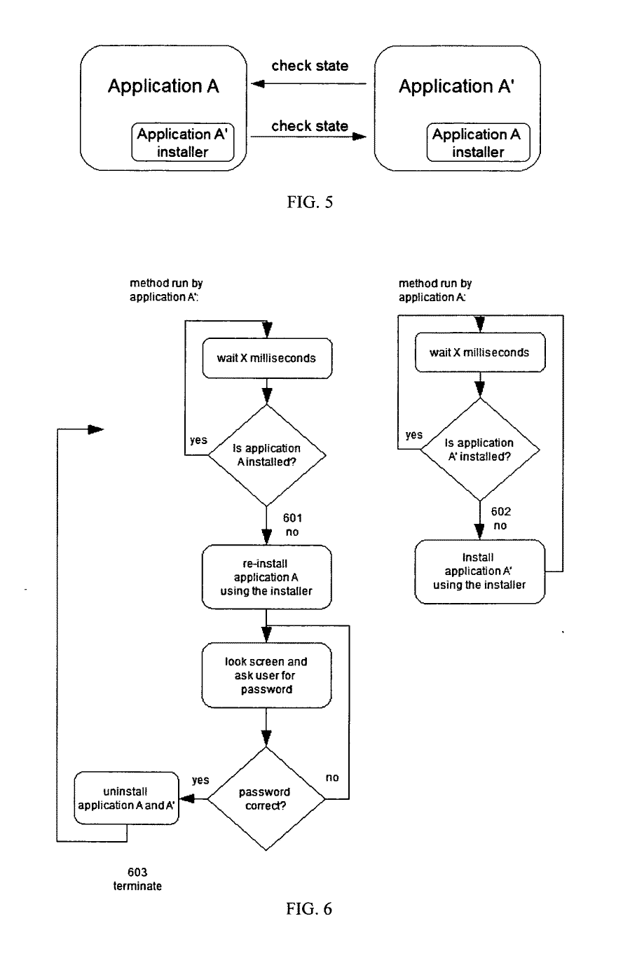

The uninstall protection mechanism in accordance with one aspect of the present invention is a general process that is applicable to all software; not just the gTrack software. This general process is illustrated in FIG. 5 which shows a general application A co-working with a dual (often running in the background) application A′. Within each application, there is an installer module to install its dual application. Within application A, an installer module that will re-install application A′, whenever application A′ is improperly uninstalled; within application A′, there is an installer module that will re-install application A, whenever application A is improperly uninstalled. An application is said to be improperly uninstalled whenever the uninstalling is not authenticated.

FIG. 6 illustrates a possible flowchart for the dual processes. In FIG. 6, at branch 601 in the flowchart, when it is discovered that application A was not installed, application A′ will ask for verification to determine if the uninstalling is authorized. If the authorization fails, application A will be reinstalled; otherwise, application A′ will be uninstalled and be terminated 603. In a slightly different way, at branch 602, application A′ is discovered to be uninstalled—the installer in application A will reinstall application A′.

It is clear that the combined features offered by the TR-DR-PP operations will strongly inhibit a non-owner to use or sell a lost or stolen portable device. Thus, in accordance with one aspect of the present invention, a gTrack system is combined with property insurance products that protect against loss or theft of portable devices. The use of gTrack will greatly reduce the systemic risks of people stealing or not returning a lost portable device. The Track system is operated either by an insurance business or a third party vendor.

What is claimed is:

1. A system, called gTrack, for theft recovery, data recovery, and privacy protection for lost or stolen portable devices with IP connectivity, comprising:
a system of communications mechanisms to locate IP addresses to enable direct communications between two IP devices;
a system and method to store and retrieve essential data;
methods for tracking the location of lost portable devices;
wherein said communications mechanisms are conducted according to either a peer-to-peer (P2P) or client-server model; said the communications infrastructure can either be serverless or server-based; in said P2P model, search to store and retrieve data is done via a distributed hash table (DHT) algorithm; said portable devices are lightweight, enough to be hand-carried, consumer or commercial electronic devices.

2. The system of claim 1, wherein a said portable device is also trackable via two methods: a said device is equipped with a global position system receiver, or an equivalent device to determine its location coordinates; or a said device is connected at an IP address which provides the device location within proximity.

3. The system of claim 2, wherein each said device is associated with a globally unique identifier, which is set to be an email address, a phone number, or a composite identifier of the form (email address or phone number, secondary identifier).

4. The system and method of claim 3, wherein said system functions as a distributed database that stores the active IP addresses, location coordinates, and authorization passwords associated with said portable devices.

5. The system of claim 4, wherein each said portable device protected by said gTrack system, called gTrack device, is equipped with a gTrack software module; a said gTrack device is set to a locked mode if (1) a user fails to authorize in an attempt to operate the said device, (2) a user fails to authorize in an attempt to uninstall said gTrack software on the said device; an authorized user can also set a gTrack device to a locked mode by choice; wherein a said gTrack portable device in locked mode stops any user from operating the said device except through an Internet connection with proper authorization.

6. The system of claim 5, once a said gTrack device is in a locked mode, the said device sends its location coordinates to pre-selected accounts; the said device also optionally sends private data contained in the said gTrack device to pre-selected accounts, whereas private data includes, while not being restricted to, emails, chats, online account names, user names, phone call lists, contact lists, etc.

7. The system of claim 6, once a said gTrack device is in a locked mode, one or more of the following actions are to be performed:
(1) an authorized user is enabled to delete data in the form of files or entries in application data fields from the said device;
(2) alerts are sent to pre-selected accounts to inform about unauthorized operations on the said device;
(3) logging out of selected or all online accounts.

8. The system of claim 7, once a said gTrack device is in a locked mode, an authorized user is enabled to transfer data, in the form of files or entries in application data fields from the said device to a preselected storage system, which includes, while not being restricted to, a Web-based storage system and a personal computer.

9. The system of claim 8, while a said gTrack device is in not in a locked mode, an authorized user is enabled to transfer data, either on a periodic basis or manual basis, in the form of files or entries in application data fields, between the said device and a selected storage system, which includes, while not being restricted to, a Web-based storage system and a personal computer, for the purpose of data synchronization or data restoration.

10. A method to prevent unauthorized uninstalling of application computer programs, comprising:
an application computer program with an installer module;
a dual application computer program with an installer module;
wherein said application and said dual application programs are installed on an operating system (OS); either intermittently, or periodically, if said dual application program detects that said application program has been uninstalled without proper authorization, its installer module re-installs said application program on said OS; either intermittently, or periodically, if said application program detects said dual application program has been uninstalled, its installer module re-installs said dual application program on said OS.

11. The system of claim 10, wherein the method of claim 11 to prevent unauthorized install is used to protect said gTrack software applications installed on said portable devices.

12. The system of claim 11 is integrated with a property insurance product that protects against loss and theft of said portable devices such that each insured portable device is part of a gTrack system operated either by said insurance business or a third party vendor.

13. A computer-readable medium with a computer program for performing the methods as described in any one of claims 1 to 11.
